(19) United States
(12) Patent Application Publication
(10) Pub. No.: US 2003/0036913 A1
(43) Pub. Date: Feb. 20, 2003

(54) Product development process

(76) Inventors: Barbara A. Blair, Boise, ID (US); Timothy L. Carter, Caldwell, ID (US)

Correspondence Address: HEWLETT-PACKARD COMPANY, Intellectual Property Administration, P.O. Box 272400, Fort Collins, CO, 80527-2400, US

(21) Appl. No.: 09/931,825

(22) Filed: Aug. 16, 2001

(51) Int. Cl. G06F 17/60

(52) U.S. Cl. 705/1

(57) ABSTRACT

The invention provides a method for developing marketable products incorporating novel technological concepts. The method includes identifying a specific technological concept to develop into a product, selecting an initial entry vehicle product architecture for the specific technological concept by identifying an entry vehicle application that is narrow enough in scope to reduce development time but broad enough to enable additional applications, proving the technological and product concepts for the entry vehicle application, identifying additional applications for the proven technological concept; and developing derivative products based on the initial and additional applications.

### FIELD OF THE INVENTION

The present invention is related to the area of product development. Specifically the present invention provides a system for streamlining the product development process from conceptualization to presentation to the market.

### BACKGROUND OF THE INVENTION

The process of bringing products to market is often lengthy and complicated. Many businesses are based on core science or technologies that are adopted or developed by the business. Scientists employed by the business are often given the task of developing or improving these core technologies. Often the technological advances developed by the scientists are passed on to a product development group within the business for transformation into marketable products. Once a product is developed, the job of bringing the product to a consumer is given to a separate marketing or commercialization department. Thus, the product follows a linear path from conceptualization, which is controlled by scientists, to integration, which is controlled by the product development department, to presentation to consumers, which is controlled by the marketing or commercialization department.

This linear path may result in significant lag time between conceptualization and commercialization. During this lag time, competitors are given a chance to develop and market competing technologies. In addition, as the product development progresses from conceptualization to commercialization, the product concept often can become fragmented as new market opportunities are identified. This fragmentation often results in increased complexing and bureaucracy in order to develop and manage a number of product concepts and technologies in parallel. If this fragmentation is allowed to occur too early in the development, decision making becomes difficult, focus on completing the core technologies becomes diluted and the bureaucracy of the system may result in a significant number of concepts and technologies explored by the engineers and scientists never being developed into marketed products.

### SUMMARY OF THE INVENTION

The invention provides a method for developing marketable products incorporating novel technological concepts. The method includes identifying a specific technological concept to develop into a product, selecting an initial application for the specific technological concept by identifying an entry vehicle application that is narrow enough in scope to reduce development time and keep a sharp tactical focus on completing the core technologies, but broad enough to be applicable to additional applications, proving the technological concept for the application, identifying additional applications for the proven technological concept, and developing products based on the initial and additional applications.

### BRIEF DESCRIPTION OF THE FIGURES

FIG. 1 depicts components of a product development team employed by a business engaged in developing and selling products.

FIG. 2 depicts the steps of the product development process according to one embodiment of the present invention.

FIG. 3 depicts the steps of the entry vehicle process according to one embodiment of the present invention.

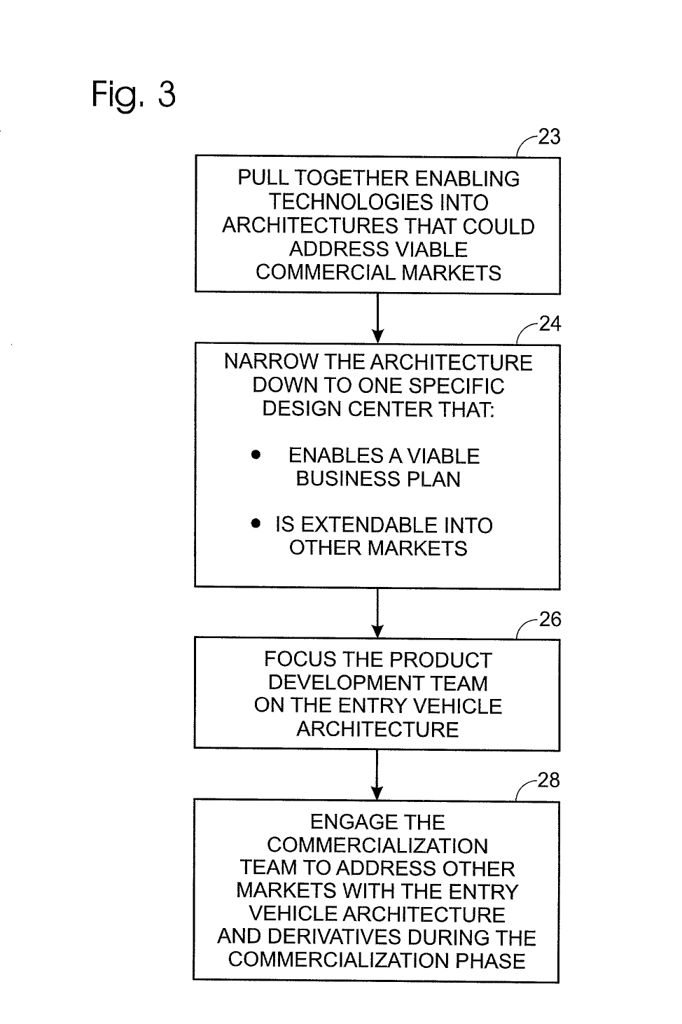

### DETAILED DESCRIPTION OF THE INVENTION

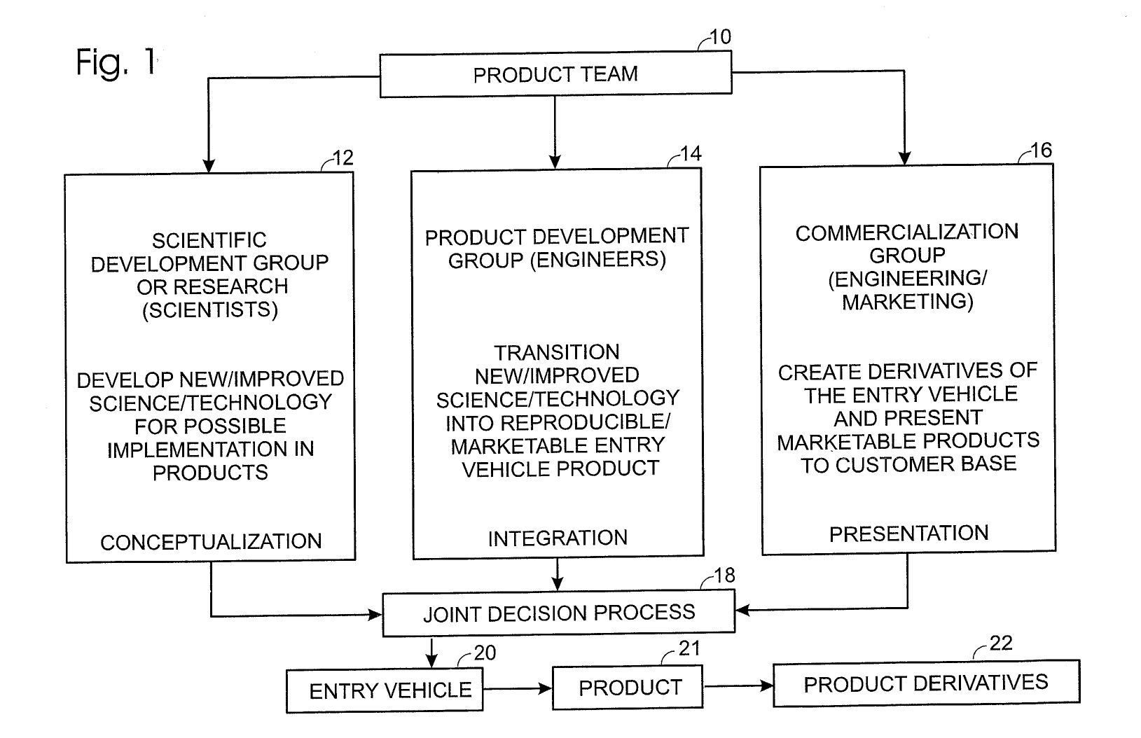

The present invention provides a system for streamlining the timeline between conceptualization of a technology and presentation of the technology in the form of a marketable product. FIG. 1 depicts components of a product team 10 including three departments commonly employed by a business engaged in developing and selling products.

The scientific development, or research, group 12 is generally made up of scientists engaged in developing new or improved science and/or enabling technology for possible implementation in products. For the purposes of this disclosure, the conceptualization phase is governed by the research group.

The product development group 14 is generally made up of engineers tasked with the job of transitioning the science or technology developed by the research group into a reproducible and marketable product. For the purposes of this disclosure, the product development phase governed by the product development group is referred to as the integration phase.

The commercialization group 16 is generally made up of people trained in product application engineering, business and marketing. Among other duties, the commercialization group is often charged with tailoring the core product to fit the needs of multiple markets and presenting marketable products to a new or existing customer base. For the purposes of this disclosure, the commercialization phase is governed by the commercialization group.

In contrast to product development processes in which the research, product development, and commercialization groups work together only when handing a project off from one group to the next, the present invention provides for these groups to work together to define an entry vehicle architecture. This entry vehicle architecture is designed to aid all of the groups by focusing the groups' efforts together in a joint decision process 18 to create an entry vehicle architecture 20, enabling the company to bring products 21 and product derivatives 22 from the conceptualization phase to the commercialization phase in a rapid and effective manner.

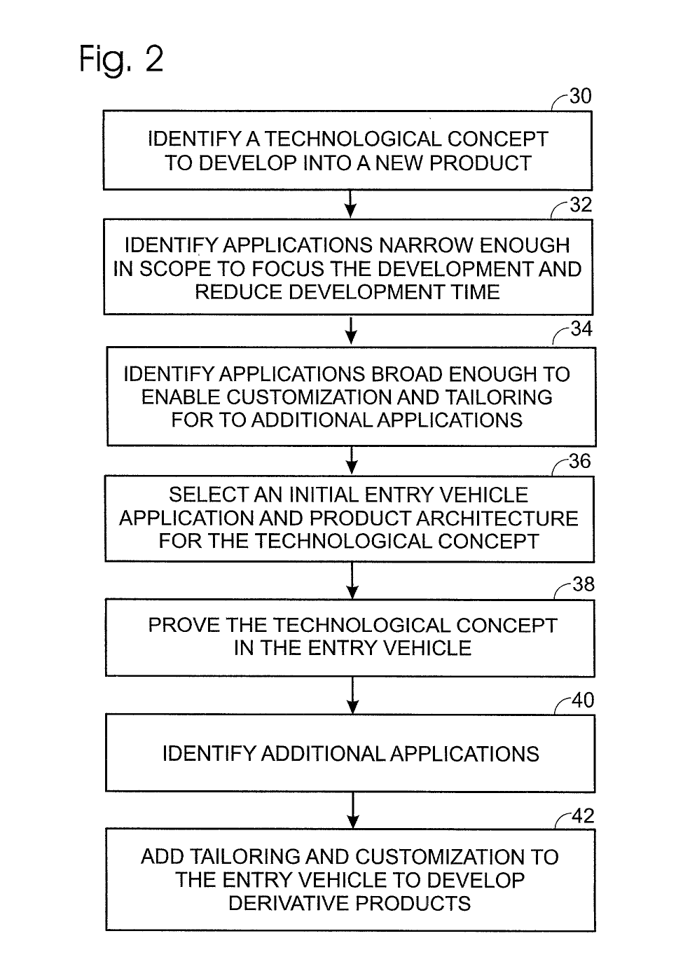

The steps of the product development process of the present invention are shown in FIG. 2. The steps for developing marketable products incorporating novel technological concepts are, identifying a specific technological concept to develop into a product 30, selecting an initial application for the specific technological concept 36 by identifying an application that is narrow enough in scope to reduce development time 32 but broad enough to be applicable to additional applications 34, proving the technological concept for the application 38, identifying additional applications for the proven technological concept 40, and developing products based on the initial and additional applications 42.

As shown in Fig, 3, the entry vehicle architecture 20 is selected by an initial evaluation of all technologies 23. The architecture is then narrowed down to one design concept that enables a viable business plan and is extendable into other markets via tailoring and customization 24. The entry vehicle architecture is selected according to the following parameters: the entry vehicle architecture should be narrow enough to enable a viable business plan and provide enough focus for the research group such that the required science or technology can be developed quickly and efficiently, but be broad enough to allow the science or technology developed by the research group to be extended into additional markets.

Most general technologies are applicable to a wide range of applications and may be developed using a wide range of specifications and materials depending upon the particular application to which the technology is to be applied. Thus, the entry vehicle architecture strategy enables the product team to focus research on a single application, greatly reducing the parameters of the research conducted by the scientists in the research group. In other words, without guidance from an entry vehicle architecture, the research group could spend significant amounts of time trying to develop technology that is applicable to every possible application, instead of focusing on a particular application that can later be expanded via tailoring and customization to apply to other fields.

Once a specific entry vehicle architecture is selected, the entire product team is tasked to focus their efforts on the specific entry vehicle architecture 26. Once the research and product development group prove that the enabling technologies are suitable for the entry vehicle architecture, the commercialization team becomes responsible for applying the technology enabled for the entry vehicle architecture to additional markets via tailoring and customization 28.

As a non-limiting example, a particular business may be engaged in developing memory storage devices for electronics. The research group may initially be tasked with finding ways to reduce the size of the memory storage devices. According to the present invention, the research, product development, and commercialization groups jointly select a suitable entry vehicle architecture to provide focus for the product development effort. Memory storage devices are used in a wide range of applications including, but not limited to rockets, cars, computers, household appliances, and small consumer electronics. Furthermore, memory storage devices may take a large number of forms ranging in size, material, capacity, etc. Thus, the most effective entry vehicle would be one that is narrow enough in scope to limit the materials, configurations, and performance objective of the memory storage device to enable the research and product development groups to conduct research and so product development in a focused manner. However, the entry vehicle should also be broad enough in application to extend to other applications once the appropriate memory storage device has been developed. Thus, an appropriate entry vehicle might be to develop a memory storage device that is appropriate for use with a credit card, ATM card or other transactional card. By selecting a “memory card” as the entry vehicle architecture, the scope of scientific research has been limited to a specific size range and materials that are compatible with transactional cards. However, memory storage devices of this size and incorporating these materials will be useful for other future applications.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinafions that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A method for developing marketable products incorporating novel technological concepts comprising:
identifying a specific technological concept to develop into a product;
selecting an initial application for the specific technological concept by identifying an entry vehicle application;
proving the technological concept for the entry vehicle application;
identifying additional applications for the proven technological concept; and
developing products based on the entry vehicle and additional applications.

2. The method of claim 1 wherein the entry vehicle application is narrow enough in scope to reduce development time by concentrating focus on a narrow solution set, but broad and flexible enough to be applicable to additional applications.

3. A system for enabling a business to develop products comprising:
a research group adapted to conduct research to develop technologies and improve developed technologies;
a product development group adapted to develop a product based on the use of, or integration of new or improved technologies;
a technological goal to be achieved by the research group;
an entry vehicle product architecture goal to be achieved by the product development group; and
a commercialization group adapted to tailor and customize the entry vehicle, market the entry vehicle product and its derivatives;
a joint decision process involving the research, product development and commercialization groups adapted to narrow the scope of research engaged in by the research group and product development group to achieve the technological goal and entry vehicle product development goal, the decision process including identifying an entry vehicle application for the technological goal.

4. The system of claim 3 wherein the entry vehicle application is narrow enough in scope to reduce development time but broad enough to enable additional applications.

5. In a business having a research group charged with conducting research to develop technologies, a product development group charged with developing entry vehicle products from those technologies, and a commercialization group charged with tailoring and customizing the entry vehicle and marketing the entry vehicle product and its derivatives, a method for streamlining a product development process comprising tasking the research group to develop technology for use in an entry vehicle application, the entry vehicle application being selected by the product development group together with the research group and commercialization group.

6. The method of claim 5 wherein the entry vehicle application is narrow enough in scope to reduce development time but broad enough to enable additional applications.
